(19) United States
(12) Patent Application Publication
(10) Pub. No.: US 2007/0179891 A1
(43) Pub. Date: Aug. 2, 2007

(54) SECURITY CONTROL METHOD FOR DATA TRANSMISSION PROCESS OF SOFTWARE PROTECTION APPARATUS AND APPARATUS THEREOF

(75) Inventors: Zhou LU, Beijing (CN); Hua Zhang YU, Beijing (CN)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: FEITIAN TECHNOLOGIES CO., LTD., Beijing (CN)

(21) Appl. No.: 11/564,464

(22) Filed: Nov. 29, 2006

(30) Foreign Application Priority Data
Jan. 27, 2006 (CN) 200610002902.4

(51) Int. Cl. G06Q 99/00

(52) U.S. Cl. 705/50

(57) ABSTRACT

The present invention relates to a secure transmission method and apparatus, particularly to a security control method for a data transmission process and a software protection apparatus using the same, where data transmitted between a computer running protected software and the software protection apparatus is in a cipher-text form, and thus a plain text does not appear in a communication line during the whole process. Moreover, since a random number is involved for scrambling and the data is encrypted, hence commands sent from the protected software to and those returned from the software protection apparatus change constantly even when the same command is sent from the sending end. In this way, it will be more difficult for a cracker to crack, thus securing the transmission of private confidential data.

### FIELD OF THE INVENTION

The present invention relates to a secure transmission method and apparatus, particularly to a security control method for a data transmission process of a software protection apparatus and an apparatus thereof

### BACKGROUND OF THE INVENTION

With the continuous development of information technologies, software emerges increasingly which is customized for various application fields or industry demands. However, a core technology is vital to whatever software. Once the core technology has been stolen or duplicated illegally by others, a resulting economic loss will be inestimable.

A software copyright protection product, as an information security apparatus, plays an important role in the software copyright protection field. This product can protect the interest of a software developer, increase profit thereof, protect the interest of a legal user, control a software distribution, and thus can prevent the software from being pirated, and ensure a periodical charging of software license fees, etc.

Dominant technologies for the software protection include technologies of hard encryption, soft encryption, certification license and the like. The hard encryption technology means that a transformation for protected sensitive information is performed completely within a hardware protection lock (for example, a dongle) without exposure to the PC side as a software protection technology.

The hard encryption technology is a relatively reliable one in theory. A method for cracking the encryption product is to get hardware-encryption-related information for a cracking analysis by listening to the data transmission of a hard encryption device. For example, for a pirate purpose, the dongle cracking tool is used to record all data interaction, which possibly occurs, by listening to all communication data when the hard encryption device is connected, and to simulate a data interaction of the hard encryption device when disconnected. Therefore in a case where fixed data are transmitted during an interaction between a host and the encryption device even with a use of the hardware encryption, a possible opportunity will be adversely given to a pirate.

### SUMMARY OF THE INVENTION

In view of above, the present invention is directed to a security control method reliable and simply configured for a data transmission process and to a software protection apparatus using the same.

In an aspect of the present invention, there is provided a security control method for a data transmission process between a software protection apparatus and a computer, wherein data are transmitted in a cipher-text form between the computer running protected software and the software protection apparatus, and the method may comprise the steps of:

encrypting or/and scrambling data or a command to be sent and generating a cipher text at a data sending end;

transmitting the cipher text;

decrypting or/and descrambling the received cipher text and generating a plain text or command at a data receiving end; and

performing a predetermined operation on the plain text or command.

Optionally, a random number may be involved in the encrypting or scrambling.

Optionally, one same random number may be involved in a roundtrip process for the data or command to verify returned data or command.

Optionally, the encryption algorithm or scrambling method for the data sending end and the decryption algorithm or descrambling method for the data receiving end may be reversible with respect to each other and be confidential.

Optionally, a use privilege varying from one user to another may be permitted for the protected software, and the encryption algorithm or scrambling method may be adopted depending upon the varying privilege.

In another aspect of the present invention, there is provided a software protection apparatus using a security control method as above, comprising a master chip and a communication module and a memory respectively connected with the master chip, wherein the communication module may be a USB interface communication module, a serial interface communication module or a parallel interface communication module.

Optionally, the master chip may be a microprocessor or a smart card chip comprising a Central Processing Unit (CPU), a Micro Controller Unit (MCU) or a Single Chip Micyoco (SCM).

Optionally, at least one of the communication module and the memory may be built in or separated from the master chip.

It can be seen from the above method and apparatus that the data transmitted between the computer running the protected software and the software protection apparatus is in a cipher-text form, and thus the plain text does not appear in a communication line during the whole process. Moreover, since the random number is involved for the scrambling and the data is encrypted, hence the commands sent from the protected software to and those returned from the software protection apparatus change constantly even when the same command is sent from the sending end. In this way, it will be more difficult for a cracker to crack, thus securing the transmission of private confidential data.

### BRIEF DESCRIPTION OF THE DRAWINGS

The present invention may be further understood from the following description with reference to the drawings in which:

FIG. 1 is a block diagram of a hardware structure according to a first embodiment of the present invention;

FIG. 2 is a block diagram of a hardware structure according to a second embodiment of the present invention;

FIG. 3 is a block diagram of a hardware structure according to a third embodiment of the present invention; and

FIG. 4 is an operational flow diagram of the security control method according to an embodiment of the present invention.

### DETAILED DESCRIPTION OF THE EMBODIMENTS

Various embodiments of the present invention will be detailed hereinafter with reference to the drawings.

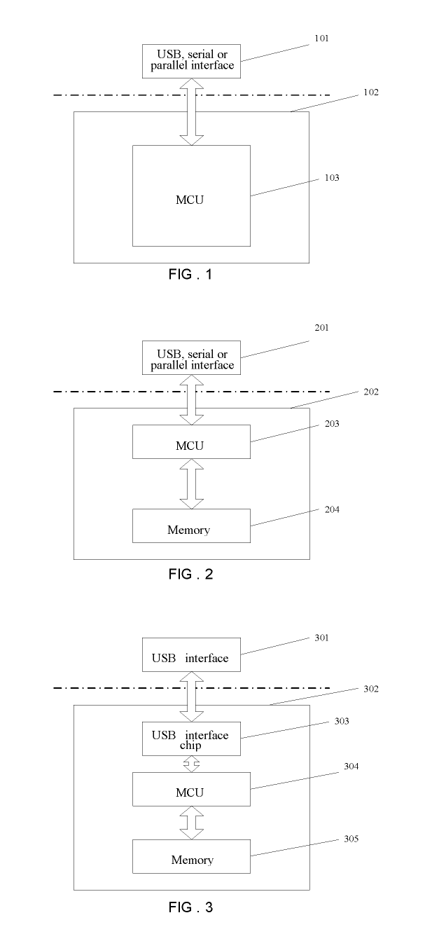

Referring to FIG. 1 illustrating a structure diagram of a software protection apparatus according to a preferred embodiment of the present invention, the software protection apparatus 102 comprises a master chip 103, which is a MCU integrated with a memory and an interface module and for a data communication, which is connected with a computer running protected software via a USB interface, a serial interface or a parallel interface 101 connected with the software protection apparatus.

With the above software protection apparatus, a security control method according to an embodiment of the present invention transmits confidential data to the software protection apparatus, returns the data from the software protection apparatus in a secure cipher text form, decrypts the data that has arrived at a destination with an agreed decryption method and further uses the decrypted data. This ensures that the plain text does not appear during the communication, and therefore the confidential data cannot be intercepted or recognized with ease. The agreed encryption and decryption algorithms or/and the scrambling and descrambling methods are reversible with respect to each other, which can be configured during a development and known only by a hardware manufacturer and a software developer. The encryption algorithm may be RSA, DES, 3DES, HMAC-MD5, TEA or the like.

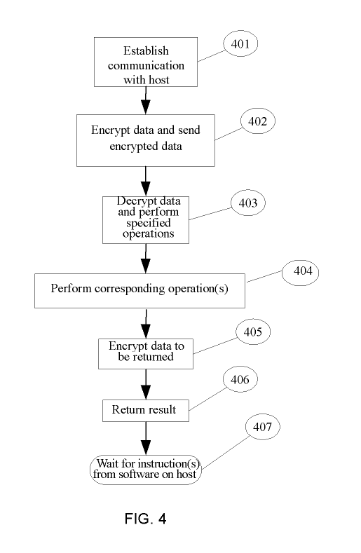

Referring to FIG. 4, a detailed process comprises the following steps.

In step 401, when a computer runs protected software, the computer detects the presence of a software protection apparatus and establishes a communication therewith.

In step 402, the computer sends encrypted data to the software protection apparatus. In particular, when the computer needs to send a command or data to the software protection apparatus, the computer scrambles the data to be sent with a random number being as a part of the data, for example, in order to scramble, the computer inserts the random number at a particular location within the data to be encrypted. Then, the computer encrypts the scrambled data with at least one encryption algorithm, and sends the encrypted data to the software protection apparatus. The randomicity of data can be enhanced by scrambling the plain text, and the resulting data is encrypted to generate the cipher text. Thus, even the same command can be processed and then transmitted to the apparatus in different cipher-text forms.

In step 403, the software protection apparatus decrypts the data and performs specified operations. In particular, the software protection apparatus decrypts the data with an agreed encryption/decryption algorithm upon reception of the data, extracts the random number inserted at the particular location, restores the data as it was, and analyzes the decrypted data. Further in step 404, the software protection apparatus performs a corresponding operation(s) as indicated in the decrypted data or command, where the extracted random number can be saved temporarily for a use in returning the data.

In step 405, the software protection apparatus encrypts the internal calculation result. In particular, upon completion of the above steps, the software protection apparatus may further encrypt and scramble the operation result when required to return. Different users can be offered cipher texts of different security levels depending upon their authorized privileges, that is, the encryption and scrambling approaches vary from one user to another. In particular, the scrambling may involve the same random number as saved previously, and thus when the data is returned, the random number can be verified after the decryption so as to achieve a verification of the operation result.

In step 406, the software protection apparatus returns the encrypted data to the host. In particular, the encrypted result is returned to the protected software on the computer. The protected software then decrypts and descrambles the data with an agreed method and applies the resultant data therein. Important data required for the software can be generated for a normal operation thereof only when the software protection apparatus is some specified valid hardware, otherwise the software suspends the operation and in this case, the software protection apparatus waits for a command from the software in step 407.

The above process control method and apparatus can ensure that the data transmitted between the computer and the apparatus is encrypted during the whole process and the plain text does not appear in the communication line. Moreover, since the random number is involved for the scrambling and the data are encrypted, hence the commands sent from the protected software to and those returned from the software protection apparatus change constantly even when the same command is sent from the sending end. In this way, it will be more difficult for a cracker to crack in that, for example, the dongle cracking tool cannot simulate the behavior of the software protection apparatus due to infinitely-increasing listening records, thus securing the transmission of private confidential data.

According to the embodiment, in addition to keep the program from illegal duplication, tracing, debugging, decompilation and the like, it is also possible to prevent the dongle cracking tool or the like from simulating the behavior of the apparatus according to the embodiment of the present invention, because the transmitted data is in a form of cipher text, scrambling or both encryption and scrambling, resulting in indefinitely-increasing listening records; and it is also possible that since the information listened by the hardware listening apparatus changes constantly, the encryption key can not be obtained and hence the cracking can be frustrated.

Referring to FIG. 2 illustrating a structure diagram according to another preferred embodiment of the present invention, a software protection apparatus 202 comprises a MCU 203 integrated with an interface module and a memory 204 connected with the MCU, and for a data communication, the software protection apparatus is connected with a computer running protected software via a USB interface, a serial interface or a parallel interface 201 connected with the software protection apparatus.

Referring to FIG. 3 illustrating a structure diagram according to a third embodiment of the present invention, a software protection apparatus 302 comprises a MCU 304 used as a master chip and a communication module 303 and a memory 305 respectively connected with the master chip, where the communication module 303 is a USB interface chip, and for a data communication, and the software protection apparatus is connected to the computer running the protected software via a USB interface 301.

Process control methods and detailed operation processes thereof in the latter two embodiments are identical to those in the first embodiment, and the description will not be repeated here.

The embodiments of the present invention can be implemented in various ways with security levels thereof being customizable, and an apparatus corresponding therewith can be simple and easy to use, which is rather important to the security of the protected software.

Although the security control method for a data transmission process and the software protection apparatus using the same have been detailed by way of the embodiments of the present invention, it shall be recognized by those skilled in the art those embodiments are merely illustrative and not restrictive, that the present invention will be never limited to those embodiments, and that various modifications and variations can be made thereto in light of the description and the drawings without departing from the spirit and scope of the present invention as defined by the accompanied claims.

What is claimed is:

1. A security control method for a data transmission process between a software protection apparatus and a computer, wherein data is transmitted in a cipher-text form between the computer running protected software and the software protection apparatus, and the method comprises the steps of:
1) encrypting or/and scrambling data or a command to be sent and generating the cipher text at a data sending end;
2) transmitting the cipher text;
3) decrypting or/and descrambling the received cipher text and generating a plain text or command at a data receiving end; and
4) performing a predetermined operation on the plain text or command.

2. A security control method according to claim 1, wherein a random number is involved in the encrypting or scrambling.

3. A security control method according to claim 2, wherein one same random number is involved in a roundtrip process for the data or command to verify returned data or command.

4. A security control method according to claim 1, wherein the encryption algorithm or scrambling method for the data sending end and the decryption algorithm or descrambling method for the data receiving end are reversible with respect to each other and are confidential.

5. A security control method according to claim 2, wherein the encryption algorithm or scrambling method for the data sending end and the decryption algorithm or descrambling method for the data receiving end are reversible with respect to each other and are confidential.

6. A security control method according to claim 3, wherein the encryption algorithm or scrambling method for the data sending end and the decryption algorithm or descrambling method for the data receiving end are reversible with respect to each other and are confidential.

7. A security control method according to claim 1, wherein a use privilege varying from one user to another is permitted for the protected software, and the encryption algorithm or scrambling method is adopted depending upon the varying privilege.

8. A security control method according to claim 2, wherein a use privilege varying from one user to another is permitted for the protected software, and the encryption algorithm or scrambling method is adopted depending upon the varying privilege.

9. A security control method according to claim 3, wherein a use privilege varying from one user to another is permitted for the protected software, and the encryption algorithm or scrambling method is adopted depending upon the varying privilege.

10. A software protection apparatus using a security control method according to claim 1, comprising a master chip and a communication module and a memory respectively connected with the master chip, wherein the communication module is a USB interface communication module, a serial interface communication module or a parallel interface communication module.

11. A software protection apparatus according to claim 10, wherein the master chip is a microprocessor or a smart card chip comprising a Central Processing Unit (CPU), a Micro Controller Unit (MCU) or a Single Chip Micyoco (SCM).

12. A software protection apparatus according to claim 10, wherein at least one of the communication module and the memory is built in or separated from the master chip.

13. A software protection apparatus according to claim 11, wherein at least one of the communication module and the memory is built in or separated from the master chip.
